(19) United States
(12) Patent Application Publication
(10) Pub. No.: US 2006/0272515 A1
(43) Pub. Date: Dec. 7, 2006

(54) Cast iron griddle particularly suited for cooking peppers

(76) Inventor: Kenneth Orr, Bonaire, GA (US)

Correspondence Address: GIFFORD, KRASS, GROH, SPRINKLE & CITKOWSKI, P.C, PO BOX 7021, TROY, MI, 48007-7021, US

(21) Appl. No.: 11/432,863

(22) Filed: May 12, 2006

Related U.S. Application Data
(60) Provisional application No. 60/680,198, filed on May 12, 2005.

(51) Int. Cl. A47J 37/10

(52) U.S. Cl. 99/422

(57) ABSTRACT

A cooking griddle having a body including a handle and an interconnected basin. A plurality of individualized and three-dimensional recesses are formed at locations across a surface area of the basin and are designed to individually hold pre-sectioned and prepared portions of selected food items (e.g. jalepeno pepper). The peppers and associated cheese fillings are thus prepared in a substantially melted and cooked condition, whereby the configuration of the seating recesses both contributes to even cooking of the underside adhering surfaces of the peppers, and combined with maintaining the positioning of the food items.

### CROSS REFERENCE TO RELATED APPLICATIONS

The present application claims the priority of U.S. Provisional Patent Application Ser. No. 60/680,198, filed May 12, 2005, and entitled Cast Iron Griddle Particularly Suited for Cooking Peppers.

### BACKGROUND OF THE INVENTION

1. Field of the Invention

The present invention relates generally to a cast iron cooking utensil, such as a griddle. More specifically, the present invention teaches a cast iron pepper griddle particularly configured for cooking such as cheese-filled jalapeno peppers and other articles which require some degree of seating retention within a cooking surface during preparation.

2. Description of the Prior Art

The prior art is well documented with various cooking (i.e., griddle) accessories for such as cooking edible items. The objective in each instance is to provide a food preparation pan or skillet for cooking any individual or range of food items.

A first example drawn from the prior art is set forth in U.S. Pat. No. 4,691,690, issued to Jenson, and which teaches a frying pan exhibiting a bottom surface with an outwardly protruding central, planar and circular areas made for contact with an electrically heated plate. Also included is a wing-shaped bottom portion on each side of the contact area. The wing-shaped portions have a periphery which account for 30-80% of the total periphery of the frying pan bottom.

Japanese Publication No. 03250577 teaches a pan constructed of aluminum or copper core, and about which is formed a stainless steel or iron. The pan is fitted with a recess, such that the inner copper or aluminum material “bulges” through the recess, an arc welding step being subsequently applied in order to improve the thermal conductivity and shorten the cooking time of the article.

Finally, U.S. Pat. No. 5,522,308, issued to Kayashima et al., teaches a griddle incorporating a temperature adjustment element for adjusting a cooking temperature for a food item such as a meat or vegetable. The griddle incorporates a thin plate exhibiting a nominal heat capacity for heating the material, an adiabatic frame for supporting the thin plate with an adiabatic structure, a plurality of heating elements for heating the thin plate, and a plurality of temperature sensors for measuring temperatures of a plurality of positions on the thin plate. A power distribution element determines power to be distributed to each of the heating elements based on the outputs from the temperature sensors and the cooking temperature.

### SUMMARY OF THE PRESENT INVENTION

The present invention discloses a cooking griddle having a body including a handle and an interconnected basin. A plurality of individualized and three-dimensional recesses are formed at locations across a surface area of the basin and which are designed to individually hold pre-sectioned and prepared portions of such as a selected food item (e.g. jalepeno pepper). The peppers and associated cheese fillings are thus prepared in a substantially melted and cooked condition, whereby the configuration of the seating recesses both contributes to even cooking of the underside adhering surfaces of the peppers, and combined with maintaining the peppers in substantially immovable position upon the griddle.

The food items are capable of being placed in seating fashion within each of the selected recesses to provide even cooking, combined with maintaining the food items in substantially immovable position upon the griddle. In the case of the food items each further including a sectioned pepper, into a recess of which is placed a volume of a meltable cheese, the configuration of the recess preventing the sectioned pepper defined recess from rotating or overturning during cooking.

The griddle exhibits a specified shape and size and is typically constructed from a cast iron material. The individualized recesses each typically further include, without limitation, a substantially oval shape to properly seat and support the food items, e.g. peppers.

### BRIEF DESCRIPTION OF THE DRAWINGS

Reference will now be made to the attached drawings, when read in combination with the following detailed description, wherein like reference numerals refer to like parts throughout the several views, and in which:

FIG. 1 is a perspective view of a skillet or griddle according to a first selected variant of the present invention and which includes a plurality of individual and three-dimensional seating recesses defined therein;

FIG. 2 is a top plan view of the griddle of FIG. 1;

FIG. 3 is a rotated bottom plan view of the griddle of FIG. 1;

FIG. 4 is a side plan view of the griddle of FIG. 1 and further illustrating the arcuate nature of the handle, basin and individualized seating recesses for cooking the individually located food items;

FIG. 5 is front plan view of the griddle of FIG. 1;

FIG. 6 is a rear plan view of the griddle of FIG. 1;

FIG. 7 is a perspective view of a griddle according to a second preferred embodiment of the present invention;

FIG. 8 is a perspective view of a griddle according to a third preferred embodiment of the present invention;

FIG. 9 is a cutaway view taken along line 9-9 of the griddle shown in FIG. 1; and

FIG. 10 is a further cutaway view taken along line 10-10 of the griddle shown in FIG. 1 according to the present invention.

### DETAILED DESCRIPTION OF THE PREFERRED EMBODIMENTS

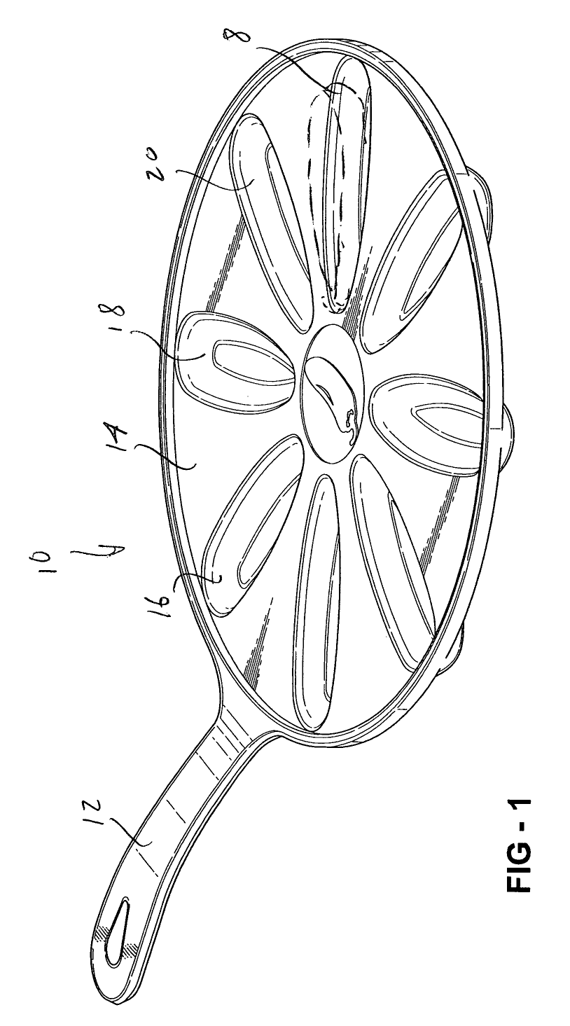

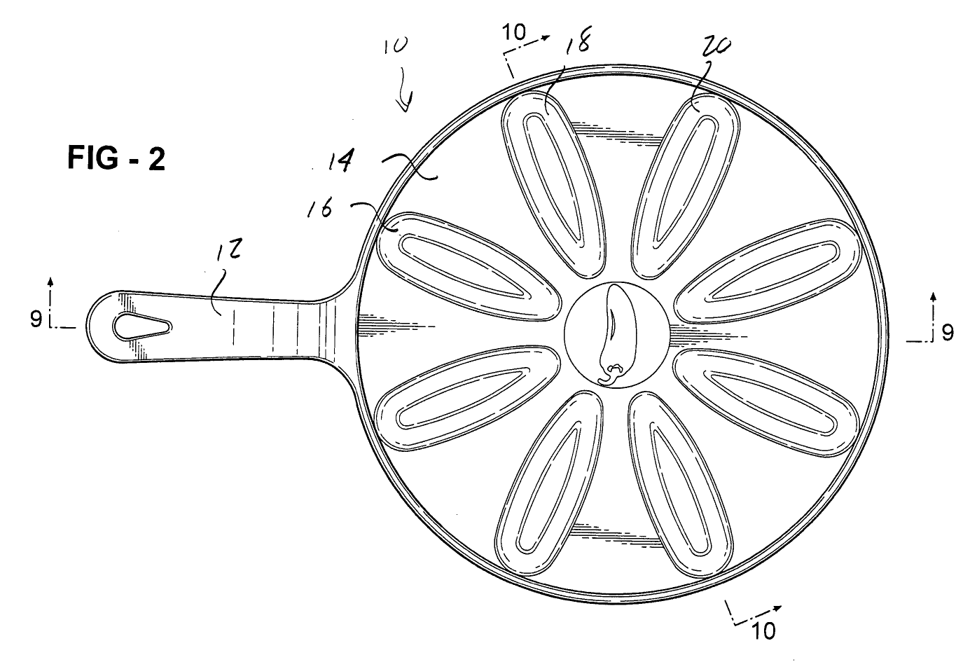

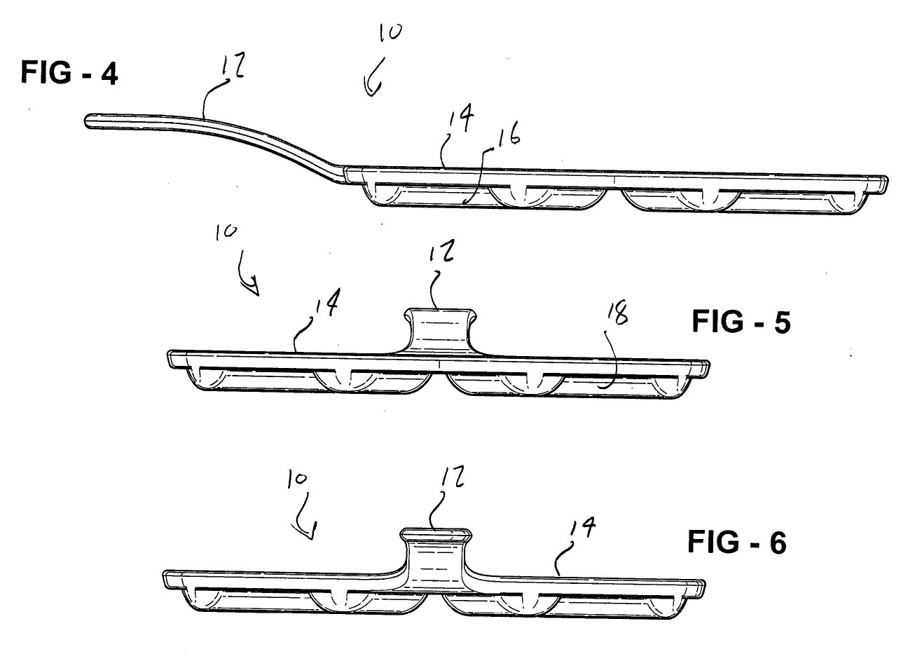

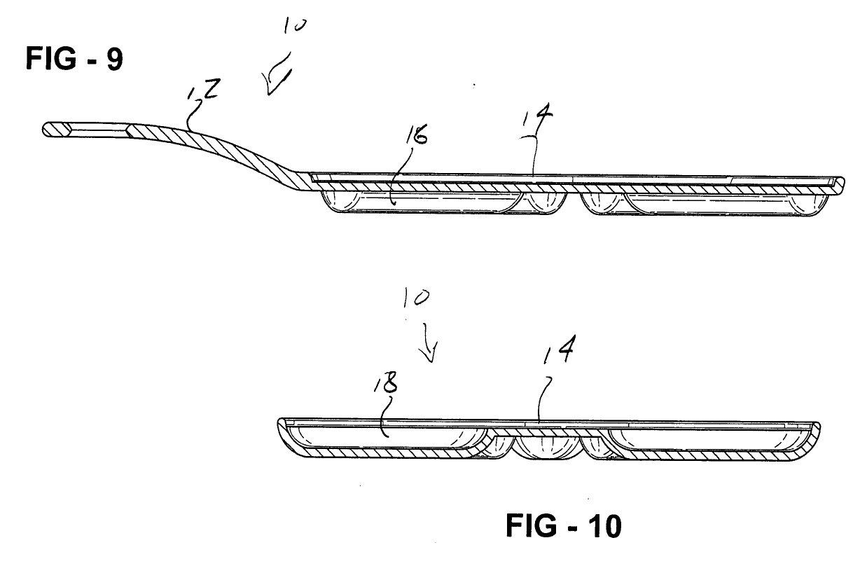

Referring now to the perspective view of FIG. 1, as well as to the succeeding plan and cutaway views of FIGS. 2-6, 9 and 10, a first embodiment 10 of a, typically smaller sized, griddle is shown according to the present invention. As previously described, the present invention discloses a cast iron cooking utensil, such as a griddle. More specifically, the present invention teaches a cast iron pepper griddle particularly configured for cooking any suitable food item, such as exemplary illustrated as cheese-filled jalapeno peppers and other articles which require some degree of seating retention within a cooking surface during preparation.

Referring again to the various drawing figures, the griddle 10 includes a heavy duty and typically metallic body, such as cast iron in a preferred embodiment. It is also understood that other material constructions, such as in particular other types of metal, exhibiting the necessary degree of heat conductivity and structural integrity can be utilized within the scope of the invention.

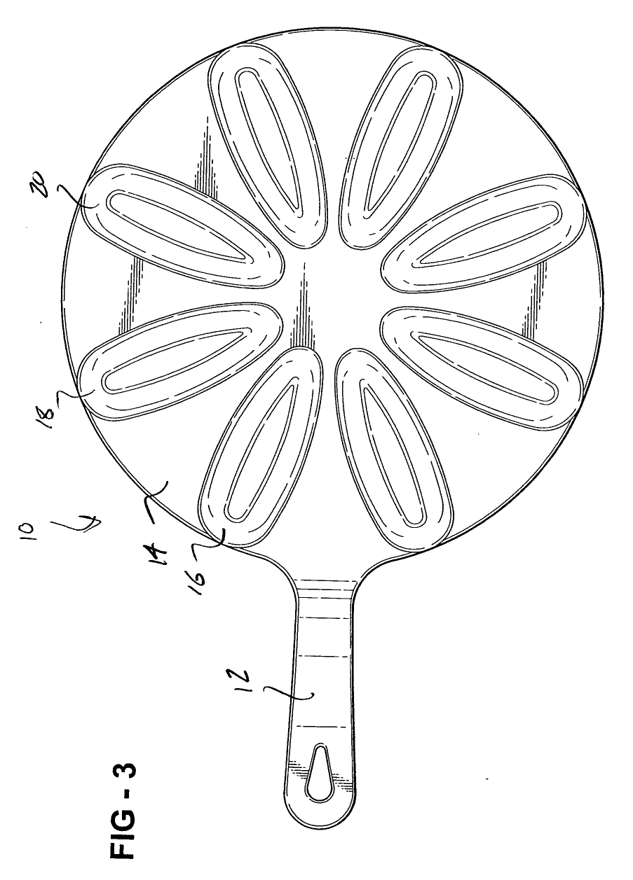

The griddle 10 includes a handle 12 and interconnected basin 14 and, as is also illustrated in the side plan view of FIG. 3, typically defines a rounded/oval and arcuate cross-sectional shape. A plurality of individual and three-dimensional seating recesses are further referenced at 16, 18, 20, etc., these being arranged (according to the first illustrated embodiment) in a spaced apart and radially arrayed/offsetting manner across the usable surface area of the griddle basin 14.

Each of the seating recesses 16, as best shown in reference again to the perspective view of FIG. 1 as well as the succeeding plan and cutaway views, include a curved (or concave/convex) shape as shown in relation to the basin 14 and depending upon whether being viewed from an upper (FIG. 2) or a lower (FIG. 3) side. It is also understood that other shapes, in addition to the generally oval shaping as shown in the drawings, can be employed without departing from the scope of the present invention, although the oval shape has been determined to be best suited for supporting in non-moving fashion a sectioned pepper portion (see as referenced in phantom at 8 in FIG. 1 and such as further filled with cheese or the like) for cooking within the griddle.

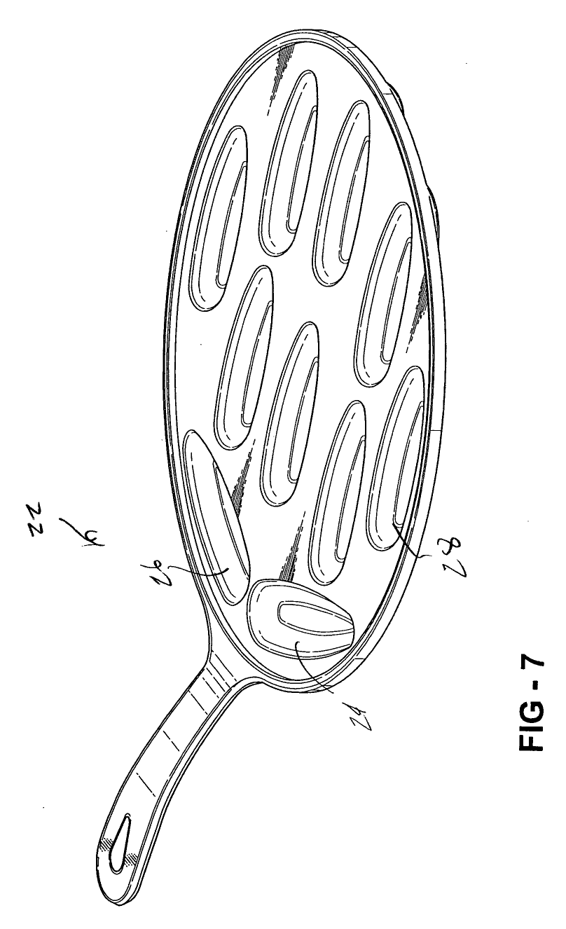

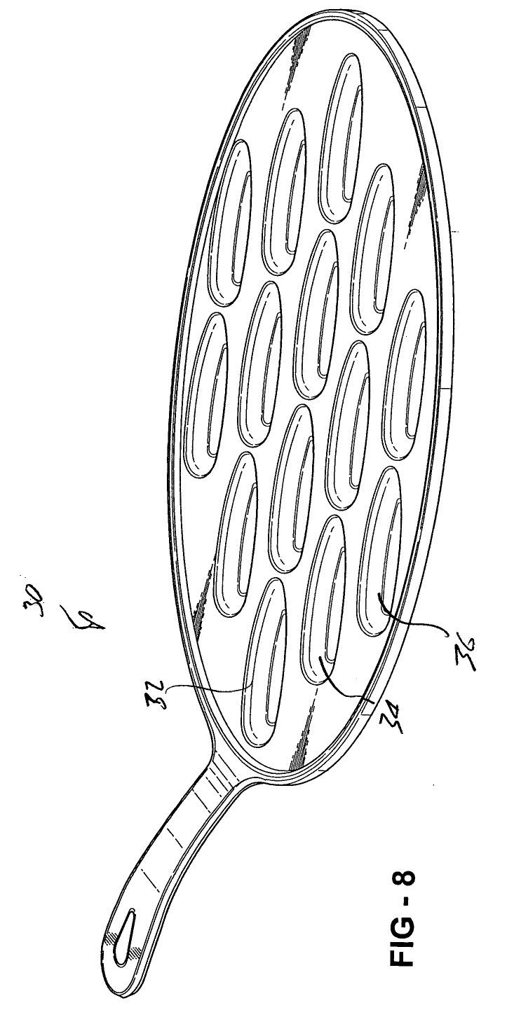

The number and arrangement of the three dimensional and concave pepper supporting recesses is contemplated to include both the radially projecting array of FIG. 1, as well as the more linearly arranged modifications in the further preferred (and typically larger) variants of FIGS. 7 and 8, respectively. The variants of FIGS. 7 and 8 represent the generally circular shaped basin of FIG. 1 in a more elongated and oval shaped fashion, this capable of supporting an increased number of individual pepper supporting recesses.

Specifically, and referencing the variant 22 of FIG. 7, a total of ten (10) individual pepper supporting recesses, eg. at 24, 26, 28, et. seq. are provided. In the further illustrated variant 30 of FIG. 8, no fewer than fourteen (14) individual pepper supporting concave recesses are shown. Otherwise, each of the griddles 22 and 30 are substantially similar to that illustrated at 10 in FIG. 1, and each includes a handle and interconnected basin and which, in a manner similar to that illustrated defines a rounded/oval and arcuate cross-sectional shape.

As discussed, the griddle design (according to any of the illustrated variants) supports the peppers and associated cheese fillings (not shown) in a substantially melted and cooked condition, whereby the configuration of the seating recesses, according to either disclosed embodiment, both contributes to even cooking of the underside adhering surfaces of the peppers, and combined with maintaining the peppers in substantially immovable position upon the griddle.

The pepper griddle primarily functions to cook and to serve appetizers, such as again including without limitation cheese-filled peppers or other types of vegetables. A feature of the griddle is again the provision and arrangement of the individualized recesses for locating and seating the individual appetizer or other food items and in a fashion such that they are completely cooked/heated (by virtue of the arcuate/concave curvature of the griddle recesses mating with the exterior sectioned configurations of the individual peppers (or other suitable food items) while at the same time being maintained in position, and such that the cheese or other meltable fluidic content held by the pepper or other suitable food item is not otherwise spilled or flow from the pepper, such as further which may result from the pepper rolling over.

Having described my invention, other and additional preferred embodiments will become apparent to those skilled in the art to which it pertains and without deviating from the scope of the appended claims.

I claim:

1. A cooking griddle, comprising:
a body including a handle and an interconnected basin; and
a plurality of individualized and three-dimensional recesses formed at locations across a surface area of said basin;
food items capable of being placed in seating fashion within each of said selected recesses to provide even cooking, combined with maintaining the food items in substantially immovable position upon the griddle.

2. The cooking griddle as described in claim 1, said cooking griddle exhibiting a specified shape and size, the food items each further including a sectioned pepper, into a recess of which is placed a volume of a meltable cheese.

3. The cooking griddle as described in claim 1, said griddle exhibiting a specified shape and size and being constructed from a cast iron material.

4. The cooking griddle as described in claim 1, said individualized recessed each further comprising a substantially oval shape.

5. The cooking griddle as described in claim 1, said basin exhibiting a specified shape in cross section including at least a circular shape, said plurality of three dimensional recesses being formed in an outwardly radially arrayed fashion.

6. The cooking griddle as described in claim 1, said basin exhibiting an elongated and substantially oval shape in cross section, said plurality of three dimensional recesses being formed in a generally linearly extending fashion.

7. The cooking griddle as described in claim 1, each of said three dimensional shaped recesses further comprising at least an elongated and concave/convex shape.

8. A cooking griddle, comprising:
a body including a handle and an interconnected and generally circular shaped basin; and
a plurality of individualized and three-dimensional recesses formed in outwardly radially projecting locations across a surface area of said basin, said individualized recessed each further comprising a substantially oval shape;
food items capable of being placed in seating fashion within each of said selected recesses to provide even cooking, combined with maintaining the food items in substantially immovable position upon the griddle.

9. The cooking griddle as described in claim 8, said cooking griddle exhibiting a specified shape and size, the food items each further including a sectioned pepper, into a recess of which is placed a volume of a meltable cheese.

10. The cooking griddle as described in claim 8, said griddle exhibiting a specified shape and size and being constructed from a cast iron material.

11. A cooking griddle, comprising:
a body including a handle and an interconnected and generally elongated and oval shaped basin; and
a plurality of individualized and three-dimensional recesses formed in generally linearly extending locations across a surface area of said basin, said individualized recessed each further comprising a substantially oval shape;
food items capable of being placed in seating fashion within each of said selected recesses to provide even cooking, combined with maintaining the food items in substantially immovable position upon the griddle.

12. The cooking griddle as described in claim 11, said cooking griddle exhibiting a specified shape and size, the food items each further including a sectioned pepper, into a recess of which is placed a volume of a meltable cheese.

13. The cooking griddle as described in claim 11, said griddle exhibiting a specified shape and size and being constructed from a cast iron material.
